(19) United States
(12) Patent Application Publication
(10) Pub. No.: US 2026/0067000 A1
(43) Pub. Date: Mar. 5, 2026

(54) RECONFIGURABLE UNDERWATER MODEM

(71) Applicant: FLORIDA ATLANTIC UNIVERSITY BOARD OF TRUSTEES, Boca Raton, FL (US)

(72) Inventors: Georgios SKLIVANITIS, Boca Raton, FL (US); Dimitris A. PADOS, Boca Raton, FL (US); Jared HERMANS, Boca Raton, FL (US); Edward A. HENDERSON, Apopka, FL (US)

(21) Appl. No.: 19/107,273

(22) PCT Filed: Jun. 30, 2023
(86) PCT No.: PCT/US2023/026760

§ 371 Date: Feb. 27, 2025

Related U.S. Application Data
(60) Provisional application No. 63/402,668, filed on Aug. 31, 2022.

(51) Int. Cl. H04B 11/00

(52) U.S. Cl. CPC H04B 11/00

(57) ABSTRACT

Low size, weight, power and cost (SWaP-C), flexible programmability and rapid run-time reconfigurability are desired features for the design of adaptive, underwater wireless communication modems for micro autonomous underwater vehicle (μAUV) swarms. Disclosed herein are first-generation and second-generation software and hardware design of a new class of low SWaP-C underwater modems that can accommodate wide-band acoustic front-ends and achieve s-level reconfigurability during run-time. By dynamically mapping certain signal processing operations of the acoustic communication stack to the Field Programmable Gate Array (FPGA) and others to the embedded processing system of the modem's System-on-Chip, data rates of up to 2000 bps can be achieved in ranges up to 50 m with the implementation of custom programmable logic.

### CROSS-REFERENCE TO RELATED APPLICATION

This application claims the benefit of U.S. Provisional Patent Application No. 63/402,668, filed on Aug. 31, 2022, and entitled “RECONFIGURABLE UNDERWATER MODEM,” the disclosure of which is expressly incorporated herein by reference in its entirety.

### STATEMENT REGARDING FEDERALLY SPONSORED RESEARCH OR DEVELOPMENT

This invention was made with government support under grant number CNS1753406 awarded by the National Science Foundation. The government has certain rights in the invention.

### BACKGROUND OF THE INVENTION

### 1. Field of Invention

This invention relates to underwater modems.

### 2. Description of Related Art

Fleets of intelligently coordinated macro/micro autonomous underwater vehicles (AUVs) can collect more data than a single ship/vehicle and offer the opportunity to study data from space-time scales not previously possible [1]-[4]. Furthermore, a group of tens/hundreds of cooperative, low-cost and flexible robots that can be easily deployed from a boat and/or aerial vehicles can offer performance benefits, for example in terms of mission completion time. Acoustic waves are the preferred signals for wirelessly coordinating such large fleets of mobile nodes. Unfortunately, commercially available underwater acoustic (UW-A) modems are: (i) large in size to fit small-size AUVs; (ii) prohibitively expensive for large-scale deployments; (iii) typically closed source, thus hampering their programmability and interoperability with other sensors and therefore their application in research [5].

Over the past few years, there has been a wide range of low-cost and low-power experimental modem prototypes developed by both academics and the industry. Seatrac [6], [7] offers a miniature acoustic modem solution that operates from 24 to 32 kHz and offers data rates from 100-1000 bps using M-ary phase shift keying (MPSK) modulation and error correction coding. SeaModem [8] is also a low-cost and low power UW-A modem that operates in similar frequencies using selectable 2-4-8 FSK modulation tones and error detection and correction algorithms. Seanet [9]-[11] provides acoustic energy harvesting and high data rate solutions of several kbit/s, however the modems are bulky and power-hungry due to the use of off-the-shelf development kits. Ahoi [5] is an opensource acoustic modem built around a micro-controller for μAUV operations that operates from 25 up to 87.5 kHz and can achieve data rates up to 4700 bps and supports bandwidths up to 37.5 kHz. The list of UW-A modems above—which is by no-means exhaustive—presents limitations and tradeoffs in size, weight, power and cost (SWaP) optimization and run-time reconfigurability to accommodate truly environment-aware adaptive UW-A communications.

The performance of underwater acoustic communication systems is measured through the bit error rate (BER) and the bandwidth efficiency, which have been subject of improvement for more than two decades of research work [1′, 2′]. Researchers have focused on different modulation techniques, starting from single carrier non-coherent modulation, coherent modulation, and nowadays, most of the scientific production is related with multi-carrier modulation techniques [1′, 3′-8′].

All references cited herein are incorporated herein by reference in their entireties.

### BRIEF SUMMARY OF THE INVENTION

Accordingly, a first aspect of the invention comprises a modem preferably configured to support software-controlled modulation adaptation between Binary Frequency Shift Keying (B-FSK) and Fast Frequency Hopping Frequency Shift Keying (FH-FSK) in real-time in an underwater environment.

A second aspect of the invention comprises a modem configured to operate underwater to provide a peak data rate of 2000 bps in a range of up to 50 m, with an on-chip power of 1.81 Watts or less.

A third aspect of the invention comprises an underwater data communications method comprising transmitting and/or receiving data with a modem of the invention.

In some implementations, the techniques described herein relate to a reconfigurable acoustic-based modem including: a first processing component; and a second processing component operatively coupled to the first processing component, wherein the reconfigurable acoustic-based modem is configured to: (i) receive and transmit data in real-time in an underwater environment, and (ii) facilitate real-time software-controlled modulation adaptation between a plurality of communication protocols using the first processing component and the second processing component in an underwater environment.

In some implementations, the plurality of communication protocols includes a first communication protocol and a second communication protocol that is different from the first communication protocol.

In some implementations, the first communication protocol includes a low-range, low-speed communication protocol, and wherein the second communication protocol includes a short-range, high speed communication protocol.

In some implementations, the plurality of communication protocols includes at least one of Binary Frequency Shift Keying (B-FSK), Fast Frequency Hopping Frequency Shift Keying (FH-FSK), and orthogonal frequency division multiplexing (OFDM).

In some implementations, the first processing component includes a field reconfigurable gate array (FPGA).

In some implementations, the reconfigurable acoustic-based modem is configured to operate underwater to provide a data rate between 2000 bits per second (bps) and 345 kilobits per second (Kbps).

In some implementations, the reconfigurable acoustic-based modem has an operational range between 50 meters and 1 kilometer (km).

In some implementations, the reconfigurable acoustic-based modem has an on-chip power between 0.5 Watts and 2.5 Watts.

In some implementations, the real-time software-controlled modulation adaptation is used to facilitate rapid switching between short-range video communication and long-range data transmission.

In some implementations, the real-time software-controlled modulation adaptation is used to facilitate rapid switching of communication parameters to avoid environmental interference.

In some implementations, the real-time software-controlled modulation adaptation is used to facilitate directional communications.

In some implementations, the reconfigurable acoustic-based modem is embodied as an acoustic beacon, underwater phone, or underwater global positioning system (GPS).

In some implementations, the reconfigurable acoustic-based modem is configured to receive and/or transmit data based at least in part on one or more user-selected parameters such as number of subcarriers, modulation, and bandwidth.

In some implementations, the techniques described herein relate to a hydrophone including: a housing; a receiver and a transmitter at least partially disposed within the housing that are configured to convert an input signal (e.g., sound wave data) that is generated or received by the hydrophone into digital signals via an analog-to-digital converter; a filtering component (e.g., bandpass filter) operatively coupled to the receiver and the transmitter that is configured to condition the input signal; and the reconfigurable acoustic-based modem.

In some implementations, the techniques described herein relate to a method including: receiving and transmitting, by a reconfigurable acoustic-based modem, data in a real-time in an underwater environment.

In some implementations, a system is provided. The system can include: a plurality of autonomous underwater vehicles (AUV) configured to operate in an underwater environment, wherein each AUV includes: a reconfigurable acoustic-based modem including: a first processing component (e.g., FPGA); and a second processing component (e.g., processor) operatively coupled to the first processing component, wherein the reconfigurable acoustic-based modem is configured to: (i) receive and transmit data in real-time in an underwater environment, and (ii) facilitate real-time software-controlled modulation adaptation between a plurality of communication protocols using the first processing component and the second processing component in an underwater environment.

In some implementations, the plurality of AUVs is configured as a mesh network.

In some implementations, the plurality of communication protocols includes a first communication protocol and a second communication protocol that is different from the first communication protocol.

In some implementations, the first communication protocol includes a low-range, low-speed communication protocol, and the second communication protocol includes a short-range, high-speed communication protocol.

In some implementations, the plurality of communication protocols includes at least one of Binary Frequency Shift Keying (B-FSK), Fast Frequency Hopping Frequency Shift Keying (FH-FSK), and orthogonal frequency division multiplexing (OFDM).

In some implementations, each first processing component includes a field reconfigurable gate array (FPGA).

In some implementations, each reconfigurable acoustic-based modem is configured to operate underwater to provide a data rate between 2000 bits per second (bps) and 345 kilobits per second (Kbps).

In some implementations, each reconfigurable acoustic-based modem has an operational range between 50 meters and 1 kilometer (km).

In some implementations, each reconfigurable acoustic-based modem has an on-chip power between 0.5 Watts and 2.5 Watts.

In some implementations, the real-time software-controlled modulation adaptation is used to facilitate rapid switching between short-range video communication and long-range data transmission.

In some implementations, each reconfigurable acoustic-based modem is embodied as an acoustic beacon, underwater phone, or underwater GPS.

In some implementations, the real-time software-controlled modulation adaptation is used to facilitate directional communications.

In some implementations, each reconfigurable acoustic-based modem is embodied as an acoustic beacon, underwater phone, or underwater global positioning system (GPS).

In some implementations, each reconfigurable acoustic-based modem is configured to receive and/or transmit data based at least in part on one or more user-selected parameters such as number of subcarriers, modulation, and bandwidth.

### BRIEF DESCRIPTION OF SEVERAL VIEWS OF THE DRAWINGS

The invention will be described in conjunction with the following drawings, wherein:

FIG. 1 shows a photograph of a low SWaP-C Zynq-SoC-based transceiver board (127×60.96 mm).

FIG. 2 shows a UW-A modem analog front-end.

FIG. 3 shows a custom IP for finite impulse response (FIR) coefficient reloading.

FIG. 4 shows a custom IP for frame synchronization, energy detector and bit decision.

FIG. 5 shows a demonstration of run-time reconfigurability, by dynamically switching from B-FSK to FFH-FSK and vice-versa.

FIG. 6 shows B-FSK simulation results with UW-A multipath channel.

FIG. 7A and FIG. 7B each show an FFH-FSK spectrogram from loopback communication where the modems communicate over a wire and in a water tank.

FIG. 7C and FIG. 7D each show an FFH-FSK spectrogram from loopback communication where the modems communicate wirelessly.

FIG. 8A illustrates an exemplary system setup of single-hydrophone underwater acoustic beacon and a triangular hydrophone acoustic array receiver according to an implementation described herein.

FIG. 8B is an example network according to an implementation described herein.

FIG. 8C is an example system according to an implementation described herein.

FIG. 8D is an example computing device.

FIG. 9A is a proposed UW-A Orthogonal Frequency Division Multiplexing (OFDM) system according to an implementation described herein.

FIG. 9B is an example Digital Upconverter (DUC) according to an implementation described herein.

FIG. 9C is a graph showing frequency response of a 512-tap complex FIR filter vs a two-stage CIC filter according to an implementation described herein.

FIG. 9D depicts Zadoff-Chu synchronization symbol.

FIG. 9E is a graph depicting channel sounding with OFDM frame synchronization symbol with TC-4034 in a lab tank.

FIG. 9F is a graph depicting channel sounding with OFDM frame synchronization symbol with TC-4034 in a pool.

FIG. 9G is a laboratory tank setup with TC-4013 and TC-4034 transmit and receive hydrophones.

FIG. 9H is a pool setup with TC-4034 transmit and receive hydrophones.

FIG. 9I shows Low SWaP-C modems interfaced with TC-4013 and TC-4034 hydrophones.

FIG. 9J shows Ideal vs underwater channel FFT input spectrum with TC-4013, fc=125 kHz, effective bandwidth of 35 kHz in the lab tank.

FIG. 9K shows a received constellation with K=NFFT=4096 with TC-4013 in the lab tank.

FIG. 9L shows Ideal vs underwater channel FFT input spectrum with TC-4034, fc=290 kHz, effective bandwidth of 175 kHz in the lab tank.

FIG. 9M shows FFT input spectrum with with TC-4034, fc=290 kHz, eB=175 kHz in a pool.

FIG. 9N shows Received constellation with K=NFFT=8192 OFDM with TC-4034 in the tank.

FIG. 9O shows error vector magnitude of K=NFFT=8192 OFDM with TC-4034 in the lab tank.

FIG. 9P shows received constellation with K=NFFT=16384 OFDM with TC-4034 in the tank.

FIG. 9Q shows received constellation with K=NFFT=8192 OFDM with TC-4034 in the pool.

### DETAILED DESCRIPTION OF PREFERRED EMBODIMENTS OF THE INVENTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. The terms “reconfigurable” and “reprogrammable” are used interchangeably herein. While implementations will be described for reconfigurable/reprogrammable acoustic-based modems, it will become evident to those skilled in the art that the implementations are not limited thereto, but are applicable for other underwater devices and systems.

Embodiments of the present disclosure provide software and hardware architectures of the first generation of a run-time reconfigurable SWaPC optimized UW-A wireless modem that is capable of rapidly (at the p s level) adapting during run-time its acoustic communication stack, such as operating frequency, bandwidth, and physical/medium-access-control-layer modulation to mitigate multipath-induced and/or avoid other sources of environmental interference [12]-[14]. In some examples, the modem demonstrates data rates up to 2000 bits per second (bps) in ranges up to 50 meters (m). Maximum operational bandwidth can reach up to 75 kHz. A board design and custom programmable logic were developed and evaluated in a laboratory water tank, a swimming pool, and very shallow and noisy harbor environments, considering testing distances (from 2 m to 50 m) that would be realistic for micro-AUV operations.

Embodiments of the present disclosure facilitate real-time software-controlled modulation adaptation between a plurality of communication protocols, for example, B-FSK, FH-FSK, and/or Orthogonal Frequency Division Multiplexing (OFDM). OFDM is a type of multi-carrier modulation where a large number of closely spaced, in frequency, orthogonal sub-carriers, typically in a power of 2 to facilitate efficient implementation, are combined using an inverse Fast Fourier Transform (IFFT) and transmitted in parallel to form a single wide-band signal. There are many advantages offered by OFDM including high data rate, efficient spectrum utilization and robustness against frequency selective fading, or multipath. The orthogonality of the sub carriers ensure that they do not interfere with each other, even when spaced narrowly in frequency. In the frequency domain representation before the IFFT, the data sub-carriers contain a type of modulated symbol such as QPSK or QAM. In the time domain, after the IFFT, the OFDM signal is mixed onto a carrier and transmitted. At the receiver, an FFT is performed to convert the OFDM signal back to the frequency domain where the sub-carriers are demodulated.

### Example Apparatus

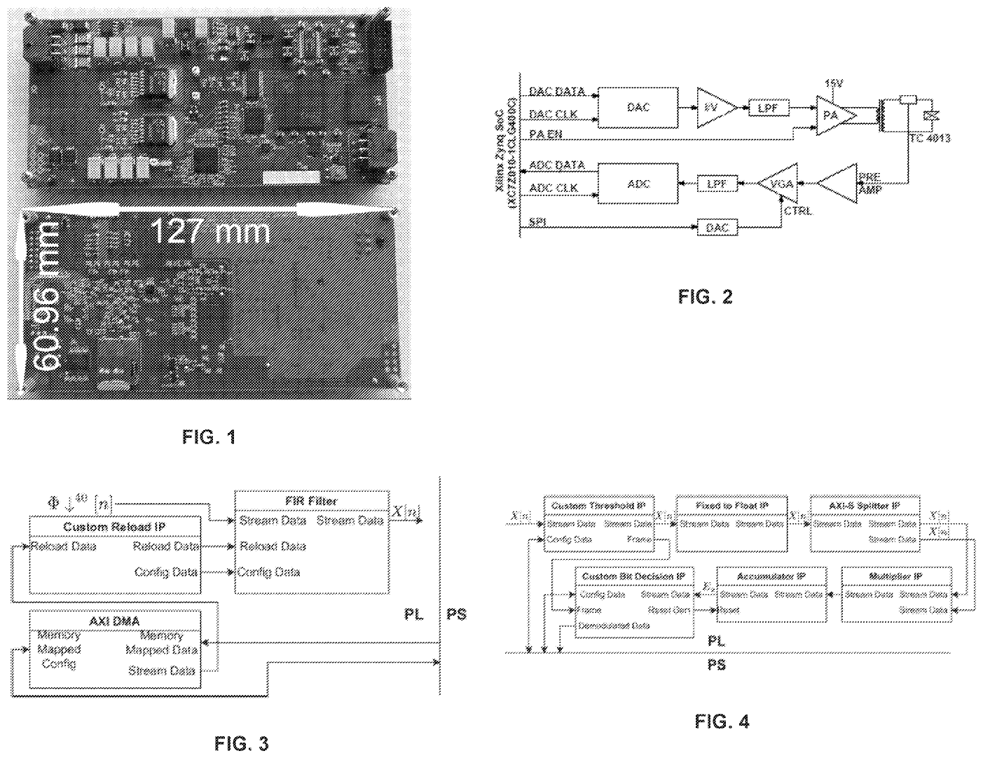

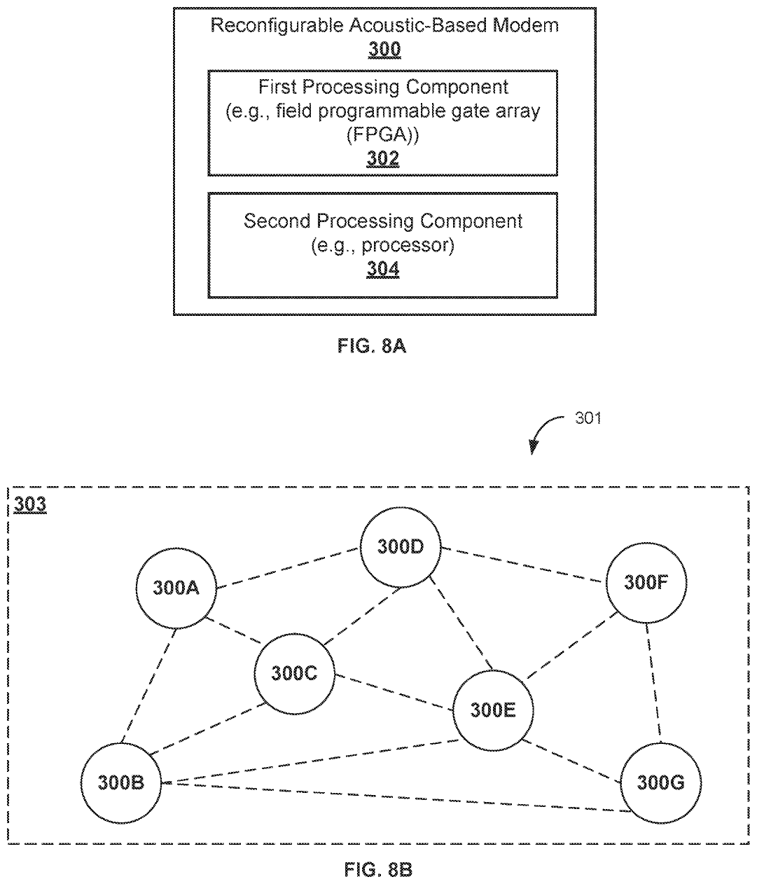

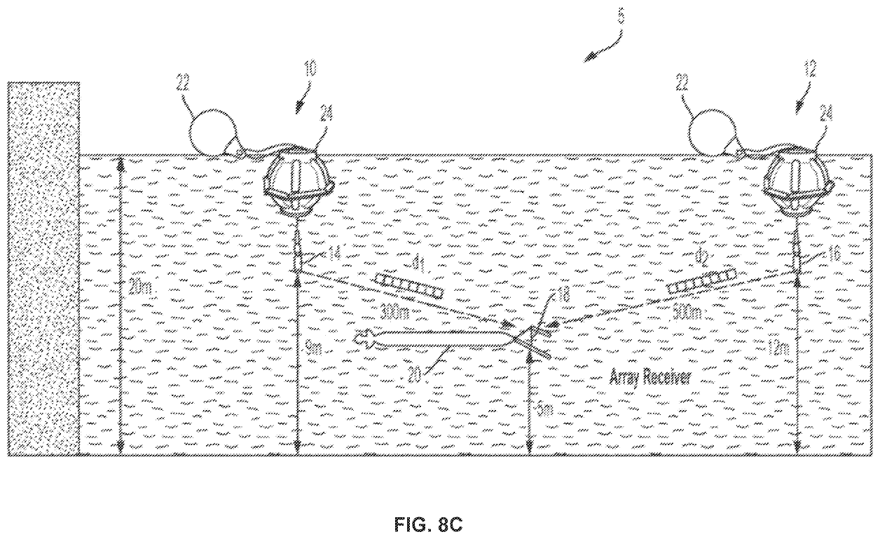

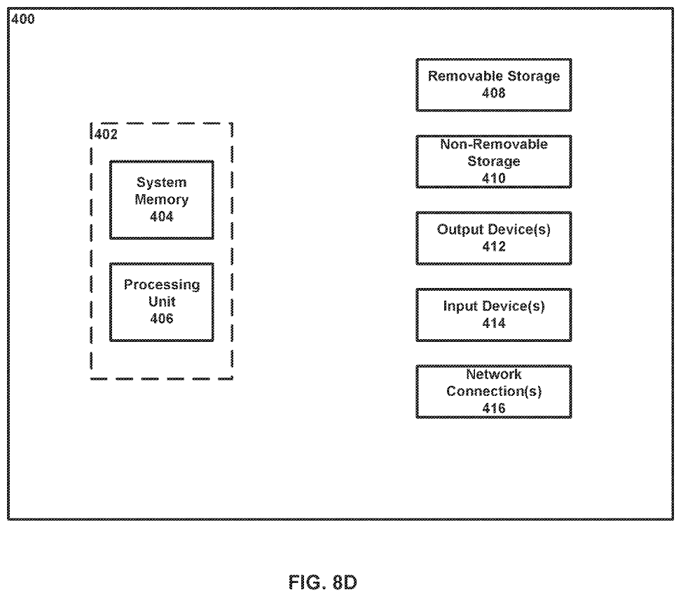

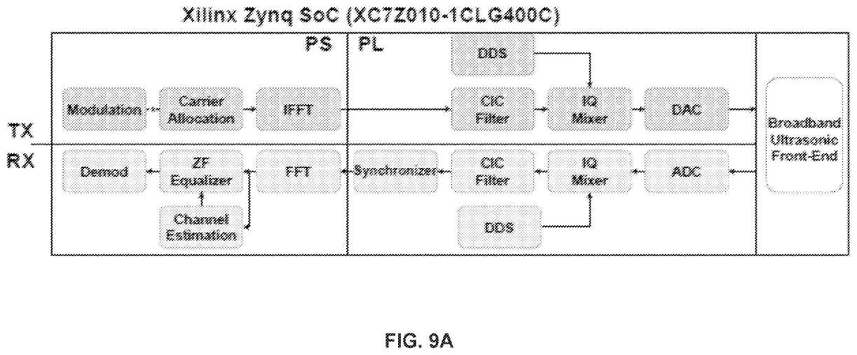

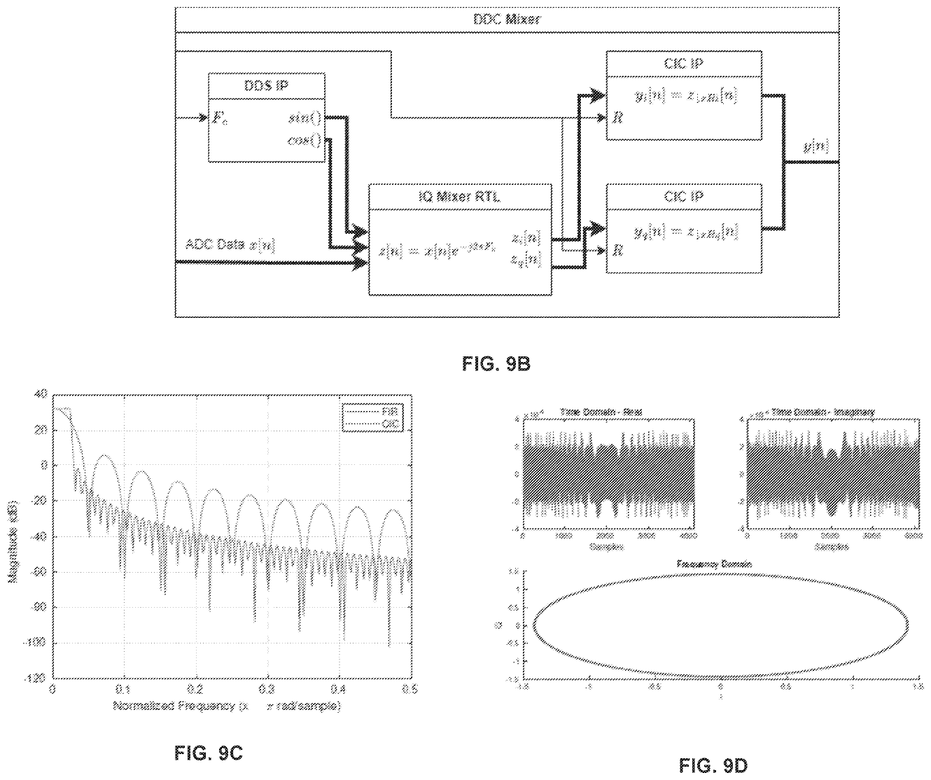

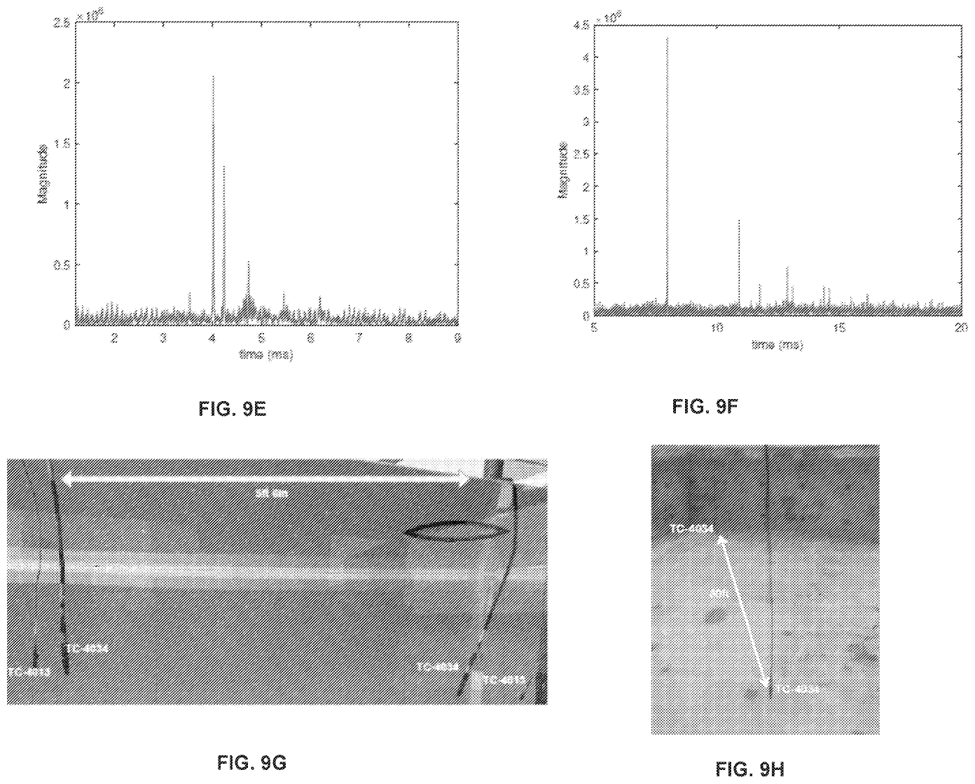

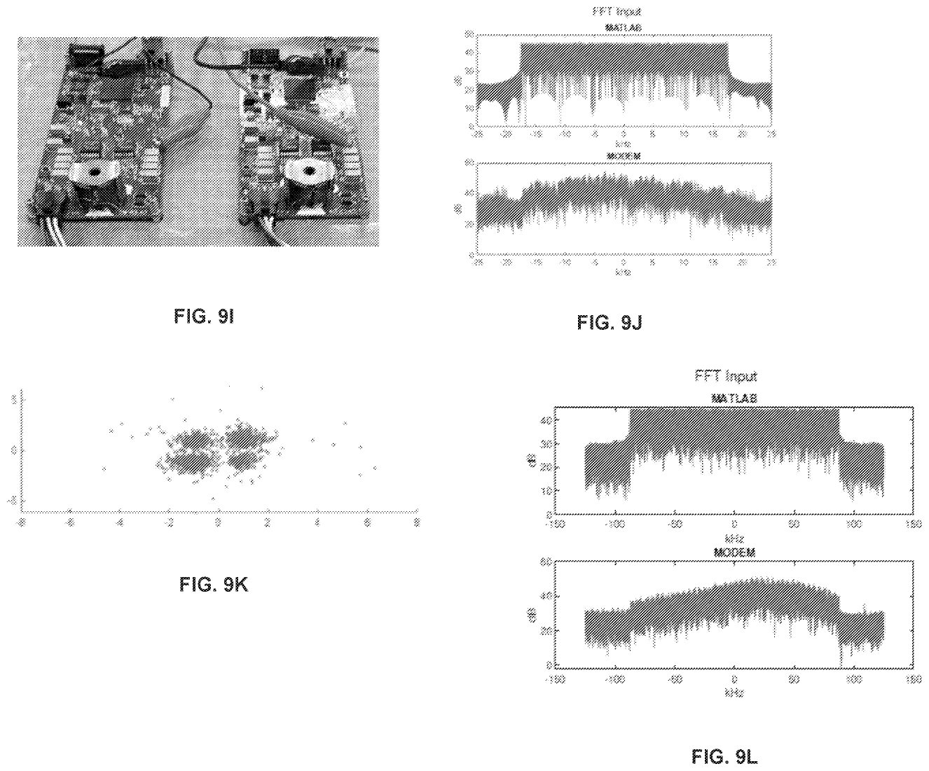

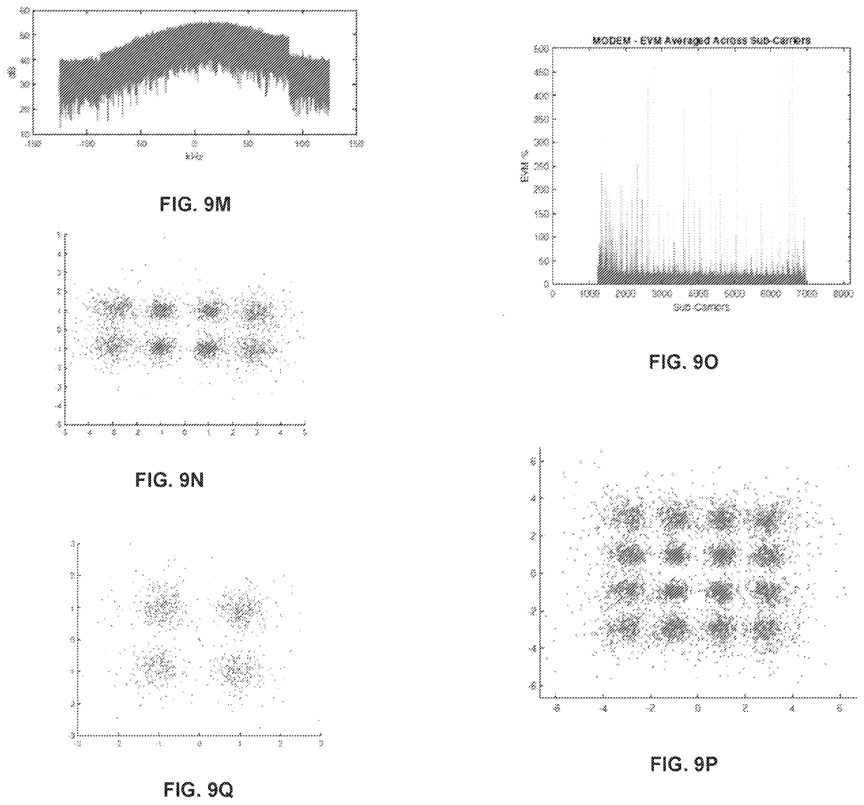

FIG. 8B is a schematic diagram depicting an example reconfigurable acoustic-based modem 300 configured for an underwater environment according to an illustrative embodiment. The example reconfigurable acoustic-based modem 300 can be configured to receive and transmit data in real time in an underwater environment. As shown, the reconfigurable acoustic-based modem 300 comprises a first processing component 302 (e.g., FPGA) and a second processing component 304 (e.g., processor). In some implementations, the reconfigurable acoustic-based modem 300 comprises or is similar/identical to the systems, devices, and/or apparatuses described in connection with FIG. 1, FIG. 2, FIG. 3, FIG. 4, FIG. 9A and FIG. 9B. The reconfigurable acoustic-based modem 300 can be or comprise an acoustic beacon, underwater phone, underwater global positioning system (GPS) hydrophone, AUV, combinations thereof, and/or the like.

By way of example, a reconfigurable acoustic-based modem 300 in accordance with the present disclosure (whether embodied as a hydrophone, AUV, combinations thereof, or other device(s)) can comprise, a housing, a receiver and a transmitter, and a power source at least partially disposed within the housing that are configured to convert an input signal (e.g., sound wave data) that is generated or received by the hydrophone into digital signals via an analog-to-digital converter. The reconfigurable acoustic-based modem 300 can further include a filtering component (e.g., bandpass filter) operatively coupled to the receiver and the transmitter that is configured to condition the input signal (e.g., attenuate noise).

The reconfigurable acoustic-based modem 300 is configured to receive and transmit data in an underwater environment and/or facilitate real-time software-controlled modulation adaptation between a plurality of communication protocols (e.g., a first communication protocol and a second communication protocol that is different from the first communication protocol) using the first processing component 302 and the second processing component 304. In various implementations, the real-time software-controlled modulation adaptation is used to faciliate: (i) rapid switching between short-range video communication and long-range data transmission, (ii) rapid switching of communication parameters to avoid environmental interference, and/or (iii) directional communications.

In some implementations, the first communication protocol is a low-range, low-speed communication protocol, such as, but not limited to, binary frequency shift keying (B-FSK) and frequency hopping shift keying (FH-FSK), which are similar to the Bluetooth standard. In some implementations, the second communication protocol is a short-range, high-speed communication protocol, such as, but not limited to, orthogonal frequency division multiplexing (OFDM), which is similar to Wi-Fi and the fifth-generation mobile network (5G). The reconfigurable acoustic-based modem 300 can facilitate rapid switching between short-range video communication and long-range data transmission. In some embodiments, the first communication protocol comprises B-FSK and/or FH-FSK and the second communication protocol comprises OFDM. In some embodiments, the reconfigurable acoustic-based modem 300 is configured to receive and/or transmit data based at least in part on one or more user-selected parameters such as number of subcarriers, modulation, and bandwidth. In some implementations, the reconfigurable acoustic-based modem 300 can be configured to operate underwater to provide a data rate between 2000 bps and 345 kilobits per second (Kbps). In some examples, the reconfigurable acoustic-based modem 300 has an operational range between 50 meters and 1 kilometer (km). In some examples, the reconfigurable acoustic-based modem 300 has an on-chip power between 0.5 and 2.5 Watts.

### Example Network

FIG. 8B is a schematic diagram depicting an example network 301 according to an illustrative embodiment. The network 301 comprises a plurality of reconfigurable acoustic-based modems 300A, 300B, 300C, 300D, 300E, 300F, and 300G. In various implementations, the plurality of reconfigurable acoustic-based modems 300A, 300B, 300C, 300D, 300E, 300F, and 300G are configured to receive and transmit data to one another in an underwater environment 303. As shown, the plurality of reconfigurable acoustic-based modems 300A, 300B, 300C, 300D, 300E, 300F, and 300G can define and/or be configured as a mesh network where each modem operates as a node within the network 301. The plurality of reconfigurable acoustic-based modems 300A, 300B, 300C, 300D, 300E, 300F, and 300G can be configured to self-localize and/or determine a location of another node within the network 301 in the underwater environment.

### Example System

FIG. 8C depicts an exemplary system 5 having two beacons 10, 12 shown deployed in a 20 m deep UW-A channel. In various implementations, the system 5 can be used for self-localization and localization of other beacons. Each beacon 10, 12 may include a transmitter 14, 16 fixed at about 9 m and 12 m, respectively, above the seabed, and positioned about 300 m and 500 m away from a hydrophone array receiver 18 attached to an AUV 20. Each beacon 10, 12 is shown in this example attached to a buoy 22 and includes a beacon housing 24 that may house electronics for underwater communications. While not being limited to a particular configuration, each transmitter 14, 16 is attached to a respective one of the beacon housings 24 as appropriate to transmit coded data signals d1 and d2 to the array receiver 18. In the example shown in FIG. 8A, the array receiver 18 is fixed at about 5 m above the seabed. From this geometry, propagation paths and delays can be calculated for each beacon. Channel variations that account for effects such as surface scattering are introduced to simulation studies, while ambient noise is generated, for example.

Additional systems and techniques are described in more detail in U.S. patent application Ser. No. 17/622,584, filed on Dec. 23, 2021, and titled “METHOD AND APPARATUS FOR ROBUST LOW-COST VARIABLE-PRECISION SELF-LOCALIZATION WITH MULTI-ELEMENT RECEIVERS IN GPS-DENIED ENVIRONMENTS,” which is a National Stage Entry of PCT Application No. PCT/US2020/048525, filed Aug. 8, 2020, and titled “METHOD AND APPARATUS FOR ROBUST LOW-COST VARIABLE-PRECISION SELF-LOCALIZATION WITH MULTI-ELEMENT RECEIVERS IN GPS-DENIED ENVIRONMENTS,” which claims the benefit of U.S. Provisional Application No. 62/926,843, filed Oct. 28, 2019, and titled “METHOD AND APPARATUS FOR ROBUST LOW-COST VARIABLE-PRECISION SELF-LOCALIZATION WITH MULTI-ELEMENT RECEIVERS IN GPS-DENIED ENVIRONMENTS,” the contents of which are expressly incorporated herein by reference in their entirety.

### Example Computing Device

Referring to FIG. 8D, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random-access memory (RAM)), non-volatile (such as read-only memory (ROM), flash memory, etc.), or some combination of the two. This most basic configuration is illustrated in FIG. 8D by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that cause the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### Experimental Results

### First Generation (Gen 1) System

### Transceiver Board Design

The first generation (GEN1) UW-A modem is built around a custom PCB developed in-house at the Center for Connected Autonomy and AI at Florida Atlantic University [15] and is shown in FIG. 1. The board is based on the Xilinx Zynq-7000 FPGA System-on-Chip (SoC), comprising both a processing system (PS), which contains a dual-core application processor unit (APU), interconnects and many peripherals such as UART, SPI, memory controller, etc., and a programmable logic (PL) block, that contains look-up tables (LUTs), registers, block RAM, and digital signal processing (DSP) blocks [16] under the same fabric. This architecture allows for a run-time re-configurable and reconfigurable wireless system that can accommodate parallel processing of large data bandwidths from multiple front-ends with deterministic latency for next-generation underwater IoT.

The hydrophone used in GEN1 is a Teledyne RESON TC4013 awith receiving sensitivity of −211 [dB re 1V/μPa at 1 m] that is relatively flat over the operational frequency range (1 Hz to 170 kHz) and transmitting sensitivity of 130 [dB re 1 μPa/V at 1 m] at 100 kHz, omnidirectional horizontal and 270 vertical directivity patterns. Following the hydrophone to board connections shown in FIG. 2, the first component is the secondary winding of a parallel tuned transformer. A tap on the secondary winding follows the receive (RX) demodulation signal chain, while the primary winding follows the transmit (TX) modulation signal chain. From the secondary winding tap, there is a 19 dB pre-amplifier, a variable gain amplifier (VGA) (controlled via SPI), a 1 MHz low-pass filter and a 14-bit parallel 40 Msps analog-to-digital converter (ADC). After the 14-bit 10 Msps digital-to-analog converter (DAC), there is an I/V converter, 1 MHz low-pass filter, and a 5 W power amplifier to the primary winding of the transformer.

### Programmable Hardware Design

The programmable logic (PL) contains all signal processing hardware components necessary to operate either as TX or RX and a controlling Linux user space software program, on the PS, implements a high-level protocol. Due to the low frequency nature of underwater acoustic channels, all signal processing is done via direct sampling. In the PL, standard Xilinx IP is used in combination with custom IP developed in hardware description language (HDL).

As the SoC was built around a custom platform, an embedded Linux system was built, configured and compiled, from scratch. Embedded Linux consists of a first-stage boot loader, a second-stage boot loader, a device tree, a kernel image and a root file system—all together referred to as the board support package (BSP) [17]. Great effort was spent on configuring the Linux kernel and root file system to include only necessary drivers and packages to keep the system as lightweight as possible. A shared repository [15] provides all custom software, hardware, BSP, and scripts pertaining to the modem design.

Transmitter Architecture. Transmitter functionality is implemented almost entirely in the PS. Creating the modulating waveform in software in the processing subsystem (PS) instead of the PL allows for greater flexibility in waveform design, at the expense of performance. The PS is responsible for encoding the digital data—received over UART—into a waveform φ(t). The PS generates the digital samples at 1/10th of the sample rate of the DAC (due to PS-PL communication performance limitations): φ[L n Tₛ], where n=0,1, . . . M, L=10, Tₛ=1/Fₛ. As a result a ×10 interpolation FIR filter in the PL is required. The first stage of interpolation is zero packing of L=10 which adds 9 zero samples in between every sample. The spectrum of the zero-packed signal contains

$$\frac{L}{2} - 1$$

repetitions of the original spectrum every L·ω_{b}, where ω_{b} is the bandwidth of the original spectrum and 0.5·L·ωₛ/2 is the new Nyquist rate. The signal is then reconstructed with the new sample rate L·Fₛ by applying a low-pass filter with cutoff frequency ω_{b}≤ω_{c}≤ω_{b}+(0.5·ω_{f}/L−ω_{b}).

Waveform samples are sent from the PS to the PL via direct memory access (DMA). The DMA is configured in direct register mode so no Linux kernel driver is necessary to operate it—control and status registers within the DMA engine are memory mapped directly from the Linux user-space application. The device tree was also configured to allocate a large block of physically contiguous memory in which the buffers accessed by the DMA reside and where the kernel has no access, too.

GEN1 demonstrates the flexibility in waveform design in the PS with the implementation of two communications schemes: 1) Binary Freqeuncy Shift Keying (B-FSK), and Fast Frequency Hopping Frequency Shift Keying (FH-FSK) as these are described herein.

Receiver Architecture. Custom IP was created to convert the digital data received from the analog-to-digital converter (ADC) into a standardized data stream [18]. After that, a ×40 decimator is implemented to limit the number of samples coming from the ADC. This converts the data rate from 40 Msps to 1 Msps. Following clock conversion, the data stream is then digitally split into one data stream that follows the path of demodulation and another data stream that is sent to the PS via DMA to be saved to the SD card. The latter can be used to estimate SNR among other things.

1) Coefficient Re-Loadable FIR Filter: GEN1 considers the implementation of two 512-tap FIR correlators—using Xilinx FIR Compiler IP [19]. The input to both correlators is the data stream of the downsampled received data φ⬇⁴⁰ [n]. The matched filtered output of each FIR is denoted as x[n]. Each FIR has the capability of updating its coefficients from the PS via DMA and a custom IP as shown in FIG. 3.

Hardware simulation shows exact timing to reload both 512 tap filters and start filtering with the new coefficient set. Both filters are re-loaded in parallel. Each coefficient takes a single clock cycle to send. Due to the optimization and implementation of the FIR filter within the DSP columns, there are actually 516 coefficients implemented and require a specific out-of-order reload sequence [19]. A single configuration packet is also required, which is handled by the custom IP and takes a single clock cycle. With 516 clock cycles for re-loading coefficients, 1 clock cycle for configuration and 1 clock cycle to update new coefficients into the filter it takes exactly 5.18 μs to re-load both filters. In a field test, where the PS (runs Linux OS) sends new coefficients, it was measured to take less than 6 μs.

These results provide the hardware framework to support real-time, software-controlled modulation adaptation between B-FSK, FH-FSK in this first generation of the modem. Existing state-of-the-art designs for FIR filter reloading show “slow” reloading times not suitable for fast frequency hopping or real time adaptation. One such design uses partial-reconfiguration to re-program a new filter with updated coefficients, which requires 4.57 ms for a 10-tap filter [20].

2) Frame Synchronization: In a non-coherent FSK system, frame synchronization is a critical component to accurately define symbol timing in order to avoid artificially high BER [21]. The following design is a simple hardware implementation of a frame synchronizer, requiring only 51 LUTs and 46 registers for 32-bit data.

At the output of both FIR correlators, there is custom IP, shown in FIG. 4, responsible for calculating a moving window average. This essentially detects the beginning of an FSK symbol. The IP has software defined values for window size W and threshold size H. The beginning of a frame is detected when the following condition is satisfied:

$$\frac{1}{W} \cdot {\sum }_{n = 0}^{W - 1} \vert x [ n ] \vert \geq H .$$

Once the beginning of a frame is detected, symbol timing within the frame is established and window average is not calculated until the end of the frame. This approach compared to other implementations [21] has drawbacks in that optimal values for W and H must be calculated for an estimated received signal strength but benefits in keeping bit rate unaffected and resource utilization low.

3) Energy Detector: At the output of the FIR correlators, the total energy is calculated by integrating each FIR output over the duration of every symbol as follows:

$${E}_{x} = {{\sum }_{n = 0}}^{T \cdot {F}_{s}} {\vert x [ n ] \vert}^{2}$$

where T is the symbol length and Fs is the sampling frequency. In the PL this is implemented using floating point operations as they allow for a greater range than fixed-point. FIG. 4 shows the implementation of the energy detector. The accumulator is reset at every symbol.

4) Bit Decision: Custom IP was developed to perform a simple comparison between the output of each energy detector. Bit 0 or bit 1 is selected for the current symbol based on the largest energy value. The IP also generates a reset to the accumulator in the energy detector based on the values of symbol length and frame length; which are programmable.

The final recovered message is continuously written into dual-port Block RAM (BRAM), which is then accessed by the PS.

### First Generation (GEN1) Supported Communications Schemes

### A. Binary Frequency Shift Keying

Utilizing binary FSK (B-FSK) as the modem's base modulation scheme allows for some simplicity in the design. A B-FSK signal is created by shifting the carrier signal, f_{c}, by Δf based upon the bit {0,1} in the digital message being transmitted. A modulated B-FSK symbol has the form:

$${Φ}_{i}^{B - FSK} ( t ) = g ( t ) cos ( 2 π ( {f}_{c} + {m}_{i} Δ f ) t ) ,$$

$${m}_{i} ∈ \{ 0 , 1 \} , i = 1 , … , N$$

where g(t) is a rectangular pulse of duration T, and mᵢ∈{0,1}^{N} is the digital message signal. Guard band—which is defined as the time in between bits where no signal is transmitted—is defined as T_{g}. It is known that the minimum frequency separation between f_{c}=f_{c} and f₁=f_{c}+Δf to minimize error probability for B-FSK is when Δ=f=0.715/T and that the minimum frequency separation for orthogonality is Δf=½T ([22] at p. 206).

### B. Fast Frequency Hopping—Frequency Shift Keying

For the proposed SWaP UW-A modem, parameters fc, T, Tg and Δf are tunable to a wide range of values to mitigate inter-symbol interference (ISI) induced by multipath and interference from other users operating in the same frequency band. Real-time tuning of f_{c} implements a frequency hopping FSK (FH-FSK) system and the changing off f_{c} for every symbol implements a fast FH-FSK (FFH-FSK) system [23]. The modulated FFH-FSK symbol becomes similar to Eq. 1 where the carrier is updated to fⱼ for M hops as follows:

$${f}_{j} = {f}_{c} + j Δ f , j = 1 , … , M .$$

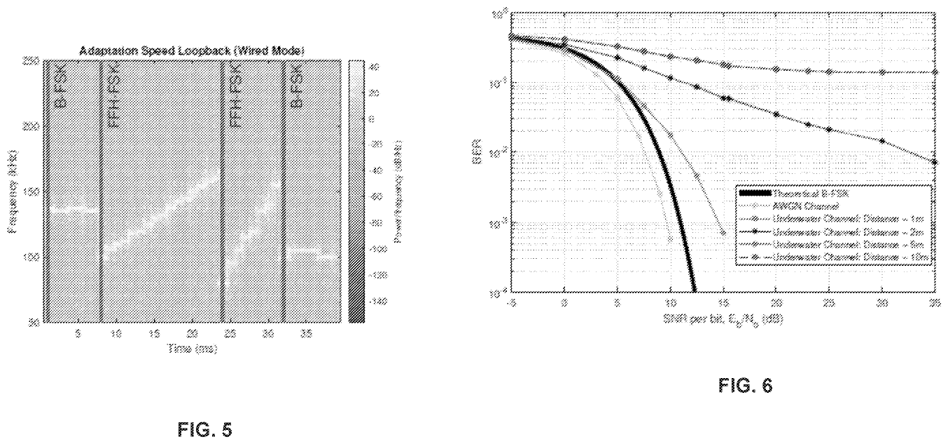

The spectrogram in FIG. 5 demonstrates rapid switching between modulation types and modulation parameters as well as accurate demodulation by the receiver. The switching pattern is pre-loaded to on-chip Lookup Tables (LUTs) at both the transmitter and the receiver. For future network deployments, artificial intelligence (AI)-assisted receivers that autonomously identify modulation types/parameters adopted by the transmitter, and thus could avoid network synchronization overheads can be implemented.

### Modem Performance Evaluation

The performance of the acoustic communication stack is characterized first in simulation. Bit error rate (BER) vs signal to noise ratio (SNR) plots were generated using the exact same architecture implemented in the modem hardware. B-FSK simulations were performed with different symbol lengths, guard bands and frequency spacing to guide the selection of optimized values pertaining to the implementation.

### A. Underwater Multipath Simulation

The inventors considered 100,000 transmissions of B-FSK symbols over additive white Gaussian noise and underwater multipath. The relationship between SNR and SNR per bit, E_{b}=Nₒ is given by SNR(dB)=E_{b}/Nₒ(dB)−10 log₁₀(nₛₐₘₚ) where nₛₐₘₚ is the number of samples in a symbol. The simulation generates a multipath UW-A channel using the acoustical method of images [24]. The optimal parameter values determined for the B-FSK implementation were used in an underwater multipath channel with 1, 2, and 5 m between hydrophones as shown in FIG. 6. It was observed that increasing hydrophone distance (in greater than 2 m) results in poor channel conditions for the selected parameters. This is due to longer multipath delays that result in ISI. Increasing guard bands between symbols can resolve intersymbol interference (ISI) at the expense of bit rate. An alternative is to use FFH-FSK which keeps the bit rate the same at the expense of bandwidth.

### B. Modem Wired Loop-back and Wireless Experiments

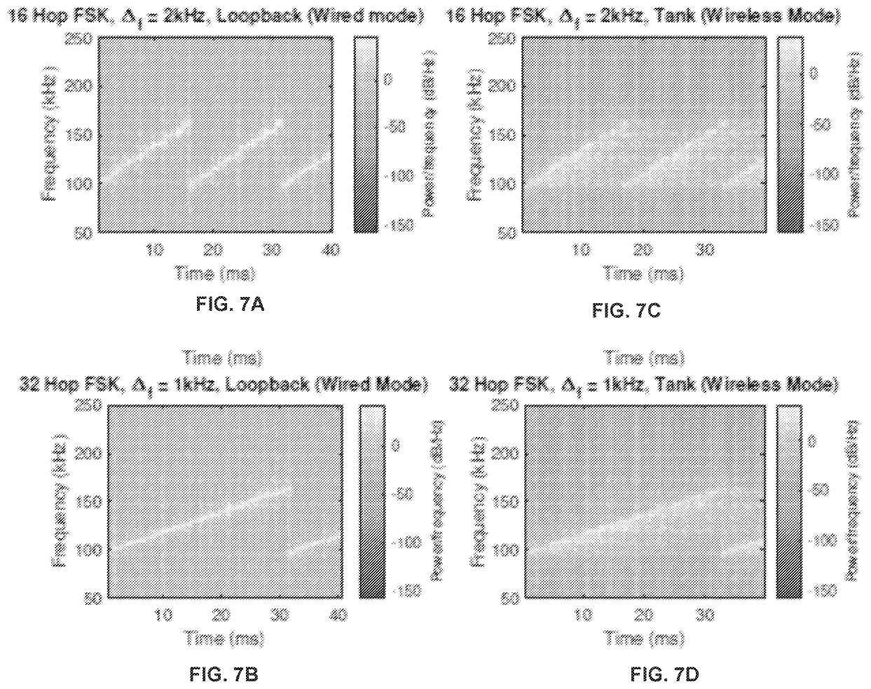

BFSK and FFH-FSK were tested in both loop-back (i.e, transmit and receive are connected with a cable) and wireless modes. FIG. 7A, FIG. 7B, FIG. 7C, and FIG. 7D show the spectrogram of a 16-hop and 32-hop FFH-FSK waveform at the receive side of the modems with a direct transmit-receive wired connection and wirelessly with 2 m separation between the hydrophones in a tank. Both modulations occupy the same bandwidth from 100 kHz to 164 kHz, where the 16-hop has 32 total f₀ and f₁ frequencies and the 32-hop has 64 frequencies. It was observed that it takes around 25 ms for multipath arrivals to die down before it is ISI-free to transmit and receive at the same frequency again.

### C. Field Testing

Initial field testing started in a 1.5 m×2.4 m×0.85 m laboratory water tank, then to a 7.62 m×9.14 m×4.57 m pool and finally to the Florida Atlantic University (FAU) Seatech harbor. The sea bottom is a combination of mud and sand and the water depth was about 2 m. The transmit and receiver transducers were placed about 1 m below the surface. Acoustic spectrum sensing during harbor tests showed significant interference in the band of operation. Bit error rates for different modulation parameters were calculated—without error correction coding—by a software program (written in C) running on the PS of both transmit and receive modems in which a known 10,000 bit random message was compared to the recovered message. Results are shown in Table I. In parallel, raw samples were saved to the SD card of the modem and plotted in FIG. 7.

TABLE I
Modem Tests

| Link | Data | | | | | | |
|---|---|---|---|---|---|---|---|
| Distance | rate | Freq.- | T_{g} | fⱼ = f_{c} + | Δf | BW = Δf + | |
| (m) | (bps) | Hops j | (ms) | jΔf (Hz) | (Hz) | 1/T (Hz) | BER |
| 2 (Tank) | 66.7 | 0 | 14 | 150k | 2k | 4k | 0.0049 |
| 2 (Tank) | 66.7 | 0 | 14 | 100k | 2k | 4k | 10⁻⁴ |
| 2 (Tank) | 500 | 16 | 1 | 100k | 2k | 64k | 0 |
| 2 (Tank) | 1000 | 32 | 0.5 | 100k | 1k | 64k | 0 |
| 2 (Tank) | 2000 | 32 | 0 | 100k | 1k | 64k | 0.1037 |
| 5 (Pool) | 58.9 | 0 | 16 | 100k | 2k | 4k | 0.00178 |
| 5 (Pool) | 500 | 16 | 1 | 100k | 2k | 64k | 0.001185 |
| 5 (Pool) | 500 | 32 | 1 | 100k | 1k | 64k | 0.0047 |
| 5 (Pool) | 1000 | 8 | 0.5 | 88k | 5k | 75k | 0 |
| 5 (Pool) | 2000 | 8 | 0 | 88k | 5k | 75k | 0.086 |
| 8 (Pool) | 25 | 0 | 39 | 100k | 2k | 4k | 0.0082 |
| 8 (Pool) | 500 | 16 | 1 | 100k | 2k | 64k | 0.0065 |
| 8 (Pool) | 1000 | 8 | 0.5 | 88k | 5k | 75k | 0.052 |
| 10 (Pool) | 23.8 | 0 | 41 | 100k | 2k | 4k | 0.006 |
| 10 (Pool) | 500 | 16 | 1 | 100k | 2k | 64k | 0.042 |
| 10 (Pool) | 1000 | 8 | 0.5 | 100k | 5k | 75k | 0.35 |
| 50 (Harbor) | 100 | 16 | 9 | 100k | 2k | 64k | 0.014 |

### D. Hardware Utilization and Power

The full PL design consisting of both transmit and receive hardware components only took 7,919 (45%) LUTs, 13,021 (37%) registers, 30.5 (50.8%) BRAM, and 49 (61.25%) DSP blocks of a Zynq-7010 FPGA SoC. Power analysis of the SoC shows total on-chip power of 1.806 W.

### Second Generation

As disclosed in detail herein, results from the development and evaluation of a highly-reconfigurable channel aware OFDM transceiver on a low size, weight, power and cost (SWaP-C) System-on-Chip (SoC) based underwater acoustic modem. Studies were conducted with broadband hydrophones in both a laboratory 3 foot (ft) and an outdoor 30 ft deep acoustic test tank. BER was measured by manually reconfiguring link bandwidth, number of subcarriers and modulation order and demonstrate link data rates up to 345 kbps in distances up to 30 ft.

### Modem Architecture.

The low-size, weight, power and cost underwater acoustic (UW-A) modem is built around a custom PCB developed in-house at the Center for Connected Autonomy and AI at Florida Atlantic University as shown in [9′]. On the transmit side, the modem receives analog baseband data from a Xilinx ZYNQ XC7Z010 System-on-Chip (SoC) [10′] that is interfaced with a 14-bit 10MSPS digital-to-analog converter (DAC) and feeds them to a power amplifier. The resulting signals are fed through a transmit/receive switch to a Teledyne RESON TC-4013 or TC-4034 miniature wideband hydrophone that is used both for projecting and receiving sound in a time division fashion. The receive side is symmetrical, with a pre-amplifiers, a variable gain amplifiers, and a 14-bit 40MSPS analog-to-digital (ADC) converter, used to convert the incoming acoustic signal to baseband, which are then fed into the Xilinx ZYNQ SoC. The operating frequency range of the TC-4013 is 1 Hz to 170 kHz and 1 Hz to 480 kHz for the TC-4034. The modem can support either broadband or narrowband transducers. These transducers were selected mainly because of the relatively wide frequency bands that they can support, which allow high data rate communications and enable the implementation of a variety of physical layer schemes. TC-4013s provide receiving sensitivity of −211 [dB re 1V/μPa at 1 m] that is relatively flat over the operational frequency range and transmitting sensitivity of 130 [dB re 1 μPa/V at 1 m] at 100 kHz. TC-4034 provide receiving sensitivity of −218 [dB re 1V/μPa at 1 m] at 250 Hz and transmitting sensitivity of 122 [dB re 1V/μPa at 1 m] at 100 kHz. Both transducers have omnidirectional horizontal and 270° vertical directivity patterns at 100 kHz (for TC-4013) and 300 kHz (for TC-4034), respectively.

### OFDM System Design

Reconfiguration Parameters. The proposed UW-A OFDM system shown in FIG. 9A is designed to be as parameratized as possible to support a wide range of environments, hydrophones and througput and resiliency requirements. Parameters such as the total number of subcarriers K, the FFT size N_{FFT}, bandwidth B, null sub-carrier K_{N} size, pilot sub-subcarriers K_{P} size, cyclic prefix length (CP), modulation order M, OFDM symbol guard period Tg, synchronization symbol root index and OFDM symbols-per-frame are all user-configurable to tailor the system to the environment and application requirements. As K increases for a given bandwidth B, both the bandwidth efficiency and the coherence between adjacent carrier increase, this causes the carrier spacing

$$Δ f = \frac{B}{K}$$

to become smaller. Parameters have the capability of configurability on a per frame basis with the exception of bandwidth which requires partial reconfiguration of the programmable logic (PL) due to the FIR filter implementation [11′].

Sub-Carrier Allocation and Resource Management. Sub-carrier allocation is an important part of designing an OFDM system to maximize spectral efficiency, optimize resource allocation, mitigate multipath and other forms of interference and ensure requirements for throughput and multi-user support [1′, 3′]. Sub-carriers are allocated as either data, pilot or null sub-carriers. Pilot sub-carriers carry known information which the receiver uses for channel estimation and equalization. Null sub-carriers are zeroed out sub-carriers typically placed at the edges of the bandwidth and at DC to prevent distortion or attenuation introduced by the digital upconverter/downconverter (DUC/DDC) and to prevent a DC offset at the transmitter or receiver.

Cyclic Prefix. In OFDM, the cyclic prefix (CP) is the ending fractional portion of the time domain OFDM symbol appended to the beginning of the OFDM symbol. At the expense of data rate and transmitted power, there are several desirable characteristics of CP [12′]: (i) Guard interval: The added CP samples between adjacent symbols provide a buffer period in the time domain, and (ii) Synchronization and frequency domain equalization: synchronization is not perfect under channel conditions and can be off several samples to several hundred samples. With CP, synchronizer offset (in time domain) is expressed as phase offset in frequency domain which is easily corrected by a frequency domain equalizer due to circular convolution properties of CP. ISI rejection: Since CP is a copy of the useful symbol, any interference affecting the CP will be eliminated during the receiver's processing.

Digital Up- and Downconversion. These conversions sit between the ADC and digital baseband stages, and comprise a frequency translation of the signal (between baseband and the modulated carrier frequency, and vice versa), and a change in sampling rate.

DDC forms part of the receiver, and is the first processing stage following the ADC. The architecture of the DDC is presented in FIG. 9B. The DDC first shifts the incoming modulated signal from a carrier frequency to baseband, by mixing it with the output of a Numerically Controlled Oscillator (NCO). The NCO is normally implemented in the FPGA/PL, with the output values coming either from a pre-computed dictionary of samples stored in a Lookup Table (LUT), or by calculating the output dynamically using a Co-Ordinate Rotation Digital Computer (CORDIC) processor. The Digital Upconverter (DUC), which is part of the transmitter, performs a similar but mirrored set of operations to the DDC. First, the low sampling rate of the digital baseband stage, fₛ, is increased to the much higher rate used by the DAC (10 MSPS), by an interpolator. The interpolated signal is then modulated by mixing it with sine and cosine signals generated by an NCO, at the desired carrier frequency, f_{c}.

Utilizing a cascaded integer comb (CIC) filter IP core [13′] and a custom IQ mixer, a low resource DUC and DDC mixer are implemented. The CIC filter is a type of FIR filter primarily used for interpolation and decimation with efficient implementation [13′]. The transfer function for the CIC filter is expressed in terms of decimation or interpolation factor and the number of stages:

$$H ( z ) = \frac{{( 1 - {z}^{- 1} )}^{N}}{1 - {z}^{-} \text{?}} \qquad ( {1}^{′} )$$

$$\text{?} \text{indicates text missing or illegible when filed}$$

where R is the decimation or interpolation factor and N is the number of stages. One drawback of the CIC filter is the frequency response as seen in FIG. 9C when compared to a 512-tap complex FIR filter. Both filters correspond to a 40× interpolation factor and a cutoff frequency of π/R=0.0257 π rad/sample, however the CIC filter has a much larger transition bandwidth and larger ripples. This will cause the OFDM spectrum towards the edges of the nyquist zone to be attenuated, and distortion—although small—will be introduced. As mentioned earlier, setting a number of null sub-carriers at the edges of the nyquist zone will avoid attenuation of data sub-carriers.

IQ mixing up-converts the complex baseband OFDM signal up to a real, passband signal at the carrier frequency. This is implemented with a programmable direct digital synthesis (DDS) IP core (which generates sine and cosine) and a complex multiplier adder:

$$Φ ( n ) = I ( n ) cos ( 2 π {f}_{c} n ) - Q ( n ) sin ( 2 π {f}_{c} n ) . \qquad ( {2}^{′} )$$

### Frame Synchronization

OFDM frame synchronization is the process of achieving accurate timing between transmitter and receiver. This is achieved with correlation at the receiver with a known Zadoff-Chu sequence transmitted as the first OFDM symbol—called a synchronization symbol. The Zadoff-Chu (ZC) sequence is selected for the synchronization symbol due to desirable autocorrelation and cross-correlation properties. Also, the ZC sequence has a low peak to average power ratio (PAPR) which allows it to be transmitted at a higher average power than the data OFDM symbols resulting in more accurate synchronization in low SNR channels. The ZC sequence is given by:

$$Z ( n ) = exp ( - j π u \frac{n ( n + 1 )}{N} ) \qquad ( {3}^{′} )$$

where u is the ZC root index and N is the length of the ZC sequence. u=13 and N=2048 were chosen and a 4096 point IFFT of the sequence taken to obtain our time domain samples shown in FIG. 9D. For the match filter in the receiver, the reverse conjugate of the time domain samples is used as taps in the in-phase (I) and quadrature (Q) 4096 tap reconfigurable FIR filters. Once the full synchronization symbol passes through the match filter, there will be a single large peak at the filter output, as shown in FIG. 9E, in which the receiver synchronizes to. The reconfigurable FIR filters allow for reloading taps corresponding to a ZC sequence of a different root index for multi-user support as ZC sequences with different root indices provide distinct sequences that exhibit low cross-correlation properties between each other.

### Channel Estimation and Equalization

Equalization is a technique used in digital communications to mitigate the effects of channel distortion and ISI at the receiver and recover the transmitted symbols. The proposed system utilizes a zero-forcing (ZF) equalizer which works by estimating the channel response using pilot subcarriers at known locations in frequency and applying the inverse of that response to the data symbols. Channel estimation occurs in the frequency domain:

$$\hat{H} [ k ] = \frac{{P}_{r} [ k ]}{{P}_{t} [ k ]} , k = 1 , … , {K}_{p} \qquad ( {4}^{′} )$$

where k is the sub-carrier index at pilot locations, Pᵣ[k] is the k-th received pilot sub-carrier and Pₜ[k] is the k-th transmitted pilot sub-carrier. Pilot selection for the ZF channel estimation is chosen to be the same modulation order as the data sub-carriers as they provide a more accurate representation of the channel characteristics. A drawback of ZF channel estimation is that in the presence of noise or interference (other than ISI), errors are introduced into the channel estimation. Errors introduced into the channel estimation can be improved with averaging techniques. However, due to the large frequency selective fading of underwater acoustic channels, this method is not employed by the proposed system. Instead, with the channel estimation at pilot locations, the channel estimate is then interpolated to include all sub-carriers K and used to equalize the data sub-carriers K−K_{N}−K_{P}:

$$Y [ k ] = \frac{X [ k ]}{\hat{H} \text{?} [ k ]} . k = 1 , … , K - {K}_{N} - {K}_{P} \qquad ( {5}^{′} )$$

$$\text{?} \text{indicates text missing or illegible when filed}$$

where X[k] is the received data sub-carrier and Ĥ[k] is the channel estimate acquired by (4′).

### Performance Evaluation

The OFDM system performance is characterized first with the TC-4013 hydrophone then with the higher bandwidth TC-4034 hydrophone. Bit error rate (BER) measurements—without error correction—were determined over the transmission of a single 16 OFDM symbol (without accounting for the synchronization sequence) OFDM frame.

Initial field testing started in a 4.9 ft×7.9 ft×2.8 ft laboratory water tank shown in FIG. 9I and moved to a 25 ft×30 ft×15 ft pool. Time domain and frequency domain samples after the DDC are saved in a parallel thread and later plotted in MATLAB. The synchronizer's matched filtered output samples are captured with an integrated logic analyzer (ILA) programmed on the PL.

Using the TC-4013 with a usable frequency range of 1 Hz to 170 kHz, an OFDM carrier is configured with a f_{c}=125 kHz, B=50 kHz, null sub-carrier density of 30%, i.e., K_{N}=1229 (effective bandwidth of 35 kHz), pilot sub-carrier density of 50% i.e., K_{P}=N_{FFT}−K_{N})*50%=1434, BPSK modulation, K=N_{FFT}=4096, CP=256, T_{g}=1 ms guard period obtains a symbol data rate of 16.464 kbps and a frame data rate of 16.28 kbps using the following:

$$bps = \frac{log \text{?} M}{T} ( {N}_{FFT} - {K}_{N} - {K}_{P} ) \qquad ( {6}^{′} )$$

$$\text{?} \text{indicates text missing or illegible when filed}$$

$$T = \frac{NFFT + CP}{B} T = \frac{NFFT + CP}{B} where T = \frac{NFFT + CP}{B}$$

for symbol data rate and

$$T = \frac{NFFT + CP}{B} + Tg$$

for frame data rate. BER was determined to be 0.007639. Increasing the modulation order to M=4 and in turn increasing symbol throughput to 32.927 kbps and frame throughput to 32.55 kbps, BER was determined to be 0.02507. The received spectrum and constellation is visibly affected by frequency selective fading from both the hydrophone frequency response and the underwater frequency response as seen in FIG. 9J. Although the spectrum is greatly distorted, at the output of the ZF equalizer, the QPSK constellation is shown in FIG. 9K.

Moving to the TC-4034 which supports larger bandwidths and higher frequencies an OFDM carrier is configured with a f_{c}=290 kHz, B=250 kHz, K_{N}=1229 (effective bandwidth of 175 kHz), KP=1434, BPSK modulation, K=N_{FFT}=4096, CP=256 and Tg=1 ms guard period obtains a symbol data rate of 82.3 kbps. BER was determined to be 0.01875 in the tank and 0.009066 in the pool (with increasing Tg=10 ms decreasing packet data rate from 77.85 kbps to 52.28 kbps with same symbol data rate). Looking at FIG. 9L and FIG. 9M, large amounts of frequency selective fading is also present just as the TC-4013.

With Integrated Logic Analyzer (ILA) capture at the matched filter output of the synchronizer in FIG. 9E and FIG. 9F, multiple peaks are seen which indicate the line of sight as well as several reverberations. In the tank, the second path echo arrives with a delay of 55 samples or 0.22 ms and the third echo arrives with a delay of 124 samples or 0.496 ms. The delay spread falls within the 256 sample CP and the 1 ms guard period. In the pool, where range has increased by about 7×, there are visible reverberations at 2.944, 3.792, 4.9, 5.132, 6.4, 6.63 and 8.2 ms. The delay spread falls within the increased Tg=10 ms guard period.

When increasing the N_{FFT} size, error vector magnitude (EVM) observably dropped allowing for an increase in modulation order. Increasing to N_{FFT}=8192 and modulation order M=8 from the previous test yielded a symbol data rate of 254 kbps, a frame data rate of 247.2 kbps and a BER of 0.0186 in the tank. EVM vs. data sub-carriers averaged across an OFDM frame is shown in FIG. 90. For the pool test, BER was higher than 0.05 so the modulation order was lowered to QPSK, shown in FIG. 9Q, dropping symbol throughput to 170 kbps and packet throughput to 131 kbps which resulted in a BER of 0.03408.

The final test increases N_{FFT}=16384 and M=16 from the previous test resulting in a 345 kbps symbol data rate, a 339.5 kbps frame data rate and a BER of 0.018 in the tank. The equalized constellation is shown in FIG. 9P. Noise and fading was too high to go above QPSK modulation in the pool test.

### CONCLUSION

The inventors designed, tested and evaluated a new class of low-SWaP UW-A that demonstrated in its first generation, μs-level communication switching between FSK and FFH-FSK for adaptive communications between micro-AUV nodes. The UW-A modem is based on a custom credit-card sized SoC which provides an unmatched flexibility, low power, low cost, high-speed, and practically unlimited customizability for next generation connected underwater autonomous systems.

It was demonstrated through extensive underwater tests that the proposed low SWaP-C underwater acoustic modem can achieve up to 345 kbps in distances up to 30 ft. The proposed implementation of a highly-reconfigurable OFDM transceiver supports multiple broadband hydrophones. Future work will focus on autonomous reconfiguration of OFDM parameters such as number of subcarriers, modulation and bandwidth for robust operation in multipath underwater environments.

While the invention has been described in detail and with reference to specific examples thereof, it will be apparent to one skilled in the art that various changes and modifications can be made therein without departing from the spirit and scope thereof.

The following patents, applications, and publications, as listed below and throughout this disclosure, are hereby incorporated by reference in their entirety herein.

### REFERENCES

[1] A. Hackbarth, E. Kreuzer, and E. Solowjow, “Hippocampus: A micro underwater vehicle for swarm applications,” in 2015 IEEE/RSJ International Conference on Intelligent Robots and Systems (IROS), 2015, pp. 2258-2263.
[2] J. Jaffe, P. Franks, D. Mirza, C. Schurgers, R. Kastner, and A. Boch, “A swarm of autonomous miniature underwater robot drifters for exploring submesoscale ocean dynamics,” Nature Communications, vol. 8, 2017.
[3] J. Shao, J. Yu, and L. Wang, “Formation control of multiple biomimetic robotic fish,” in 2006 IEEE/RSJ International Conference on Intelligent Robots and Systems, 2006, pp. 2503-2508.
[4] T. Schmickl, R. Thenius, C. Moslinger, J. Timmis, A. Tyrrell, M. Read, J. Hilder, J. Halloy, A. Campo, C. Stefanini, L. Manfredi, S. Orofino, S. Kembach, T. Dipper, and D. Sutantyo, “Cocoro—the self-aware underwater swarm,” in 2011 Fifth IEEE Conference on Self-Adaptive and Self-Organizing Systems Workshops, 2011, pp. 120-126.
[5] B. C. Renner, J. Heitmann, and F. Steinmetz, “Ahoi: Inexpensive, low-power communication and localization for underwater sensor networks and auvs,” ACM Trans. Sen. Netw., vol. 16, no. 2, jan 2020. [Online]. Available: https://doi.org/10.1145/3376921
[6] J. A. Neasham, G. Goodfellow, and R. Sharphouse, “Development of the “Seatrac” miniature acoustic modem and USBL positioning units for subsea robotics and diver applications,” in OCEANS 2015—Genova, 2015, pp. 1-8.
[7] J. Neasham, A. Chawla, B. Sherlock, and I. Loncar, “A multi-user underwater acoustic positioning system—experiments using asvs and miniature acoustic transceivers,” in OCEANS 2021: San Diego—Porto, 2021, pp. 1-5.
[8] G. Cario, A. Casavola, M. Lupia, and C. Rosace, “Seamodem: A lowcost underwater acoustic modem for shallow water communication,” in OCEANS 2015-Genova. IEEE, 2015, pp. 1-6.
[9] E. Demirors, J. Shi, A. Duong, N. Dave, R. Guida, B. Herrera, F. Pop, G. Chen, C. Casella, S. Tadayon, M. Rinaldi, S. Basagni, M. Stojanovic, and T. Melodia, “The SEANet Project: Toward a programmable Internet of Underwater Things,” in 2018 Fourth Underwater Communications and Networking Conference (UComms), 2018, pp. 1-5.
[10] R. Guida, E. Demirors, N. Dave, and T. Melodia, “Underwater ultrasonic wireless power transfer: A Battery-less platform for the Internet of Underwater Things,” IEEE Transactions on Mobile Computing, vol. 21, no. 5, pp. 1861-1873, 2022.
[11] R. Guida, E. Demirors, N. Dave, J. Rodowicz, and T. Melodia, “An acoustically powered battery-less Internet of Underwater Things platform,” in 2018 Fourth Underwater Communications and Networking Conference (UComms), 2018, pp. 1-5.
[12] E. Demirors, G. Sklivanitis, T. Melodia, S. N. Batalama, and D. A. Pados, “Software-defined underwater acoustic networks: toward a highrate real-time reconfigurable modem,” IEEE Communications Magazine, vol. 53, no. 11, pp. 64-71, 2015.
[13] A. Gannon, S. Balakrishnan, G. Sklivanitis, D. A. Pados, and S. N. Batalama, “Short data record filtering for adaptive underwater acoustic communications,” in 2018 IEEE 10th Sensor Array and Multichannel Signal Processing Workshop (SAM), 2018, pp. 316-320.
[14] G. Sklivanitis, E. Demirors, S. N. Batalama, T. Melodia, and D. A. Pados, “Receiver configuration and testbed development for underwater cognitive channelization,” in 2014 48th Asilomar Conference on Signals, Systems and Computers, 2014, pp. 1594-1598.
[15] J. Hermans, G. Sklivanitis, and D. Pados, “Center for Connected Autonomy and AI (CA-AI) Underwater Modem,” https://github.com/C2A2-at-Florida-Atlantic-University/UnderwaterModem, 2022.
[16] G. Xilinx and S. Guide, “Zynq-7000 All programmable SoC technical reference manual (ug585),” Tech. rep., Xilinx, 2014, https://www.xilinx. com/support/documentation, Tech. Rep., 2014.
[17] Xilinx, “Petalinux tools documentation, reference guide,” 2021.
[18] Xilinx, “Vitis high-level synthesis user guide,” https://docs.xilinx.com/r/en-US/ug1399-vitis-hls/Customizing-AXI4-Lite-Slave-Interfaces-in-IP-Integrator, 2022.
[19] I. LogiCORE, “FIR Compiler v5.0, Xilinx,” Inc., San Jose, CA, USA, 2010.
[20] G. Zhao, Q. Ge, and Y. Zhang, “Dynamically reconfigurable FIR filter design based on FPGA,” in 2015 Fifth International Conference on Instrumentation and Measurement, Computer, Communication and Control (IMCCC). IEEE, 2015, pp. 1631-1635.
[21] Y. Li, X. Zhang, B. Benson, and R. Kastner, “Hardware implementation of symbol synchronization for underwater FSK,” in 2010 IEEE International Conference on Sensor Networks, Ubiquitous, and Trustworthy Computing. IEEE, 2010, pp. 82-88.
[22] J. G. Proakis and M. Salehi, Digital communications. McGraw-hill New York, 2001, vol. 4.
[23] J. H. Schmidt, “Using fast frequency hopping technique to improve reliability of underwater communication system,” Applied Sciences, vol. 10, no. 3, p. 1172, 2020.
[24] J. B. Allen and D. A. Berkley, “Image method for efficiently simulating small-room acoustics,” The Journal of the Acoustical Society of America, vol. 65, no. 4, pp. 943-950, 1979.
[1′] S. Zhou and Z.-H. Wang, OFDM for Underwater Acoustic Communications. John Wiley and Sons, Inc., 2014.
[2′] T. Melodia, H. Kulhandjian, L.-C. Kuo, and E. Demirors, Advances in Underwater Acoustic Networking, ch. 23, pp. 804-852. John Wiley Sons, Ltd, 2013.
[3′] A. Radosevic, R. Ahmed, T. Duman, J. Proakis, and M. Stojanovic, “Adaptive OFDM modulation for underwater acoustic communications: Design considerations and experimental results,” IEEE Journal of Oceanic Engineering, vol. 39, pp. 357-370, April 2014.
[4′] E. Demirors, G. Sklivanitis, G. E. Santagati, T. Melodia, and S. N. Batalama, “A high-rate software-defined underwater acoustic modem with real-time adaptation capabilities,” IEEE Access, vol. 6, pp. 18602-18615, 2018.
[5′] E. Demirors, G. Sklivanitis, T. Melodia, S. N. Batalama, and D. A. Pados, “Software-defined underwater acoustic networks: toward a high-rate real-time reconfigurable modem,” IEEE Communications Magazine, vol. 53, no. 11, pp. 64-71, 2015.
[6′] G. Sklivanitis, E. Demirors, S. N. Batalama, T. Melodia, and D. A. Pados, “Receiver configuration and testbed development for underwater cognitive channelization,” in 2014 48th Asilomar Conference on Signals, Systems and Computers, pp. 1594-1598, 2014.
[7′] A. Bourr'e, S. Lmai, C. Laot, and S. Houcke, “A robust OFDM modem for underwater acoustic communications,” in 2013 MTS/IEEE OCEANS—Bergen, pp. 1-5, 2013.
[8′] S. Mangione, G. E. Galioto, D. Croce, I. Tinnirello, and C. Petrioli, “A channel-aware adaptive modem for underwater acoustic communications,” IEEE Access, vol. 9, pp. 76340-76353, 2021.
[9′] J. Hermans, G. Sklivanitis, and D. A. Pados, “A first-of-its-kind low size, weight and power run-time reconfigurable underwater modem,” in 2022 Sixth Underwater Communications and Networking Conference (UComms), pp. 1-5, IEEE, 2022.
[10′] Xilinx, “Zynq-7000 All programmable SoC technical reference manual (ug585),” tech. rep., Tech. rep., Xilinx, 2014, https://www.xilinx.com/support/documentation, 2014.
[11′] LogiCORE, “FIR Compiler v5.0, Xilinx,” Inc., San Jose, CA, USA, 2010.
[12′] S. Chen and C. Zhu, “ICI and ISI analysis and mitigation for ofdm systems with insufficient cyclic prefix in time-varying channels,” IEEE Transactions on Consumer Electronics, vol. 50, no. 1, pp. 78-83, 2004.
[13′] V. Elamaran, R. Vaishnavi, A. M. Rozario, S. M. Joseph, and A. Cherian, “CIC for decimation and interpolation using xilinx system generator,” in 2013 International Conference on Communication and Signal Processing, pp. 622-626, IEEE, 2013.
[1*] Hermans, J., Sklivanitis, G., and Pados, D. A., “SOC-Based Implementation of a Multipath-Resilient Broadband Underwater OFDM System,” in the 10^{th} Convention of the European Acoustics Association, FORUMACUSTICUM 2023.

1. A reconfigurable acoustic-based modem comprising:
a first processing component; and
a second processing component operatively coupled to the first processing component, wherein the reconfigurable acoustic-based modem is configured to:
(i) receive and transmit data in real-time in an underwater environment, and
(ii) facilitate real-time software-controlled modulation adaptation between a plurality of communication protocols using the first processing component and the second processing component in an underwater environment, wherein the plurality of communication protocols comprises a first communication protocol and a second communication protocol that is different from the first communication protocol.

2. (canceled)

3. The reconfigurable acoustic-based modem of claim 1, wherein the first communication protocol comprises a low-range, low-speed communication protocol, and wherein the second communication protocol comprises a short-range, high speed communication protocol.

4. The reconfigurable acoustic-based modem of claim 1, wherein the plurality of communication protocols comprises at least one of Binary Frequency Shift Keying (B-FSK), Fast Frequency Hopping Frequency Shift Keying (FH-FSK), and orthogonal frequency division multiplexing (OFDM).

5. The reconfigurable acoustic-based modem of claim 1, wherein the first processing component comprises a field reconfigurable gate array (FPGA).

6. The reconfigurable acoustic-based modem of claim 1, wherein the reconfigurable acoustic-based modem is configured to operate underwater to provide a data rate between 2000 bits per second (bps) and 345 kilobits per second (Kbps).

7. The reconfigurable acoustic-based modem of claim 1, wherein the reconfigurable acoustic-based modem has an operational range between 50 meters and 1 kilometer (km).

8. The reconfigurable acoustic-based modem of claim 1, wherein the reconfigurable acoustic-based modem has an on-chip power between 0.5 Watts and 2.5 Watts.

9. The reconfigurable acoustic-based modem of claim 1, wherein the real-time software-controlled modulation adaptation is used to facilitate rapid switching between short-range video communication and long-range data transmission.

10. The reconfigurable acoustic-based modem of claim 1, wherein the real-time software-controlled modulation adaptation is used to facilitate rapid switching of communication parameters to avoid environmental interference, and/or directional communications.

11. (canceled)

12. The reconfigurable acoustic-based modem according to claim 1, wherein the reconfigurable acoustic-based modem is embodied as an acoustic beacon, underwater phone, or underwater global positioning system (GPS).

13. The reconfigurable acoustic-based modem according to claim 1, wherein the reconfigurable acoustic-based modem is configured to receive and/or transmit data based at least in part on one or more user-selected parameters such as number of subcarriers, modulation, and bandwidth.

14. A hydrophone comprising:
a housing;
a receiver and a transmitter at least partially disposed within the housing that are configured to convert an input signal that is generated or received by the hydrophone into digital signals via an analog-to-digital converter;
a filtering component operatively coupled to the receiver and the transmitter that is configured to condition the input signal; and
a reconfigurable acoustic-based modem, the reconfigurable acoustic-based modem comprising:
a first processing component; and
a second processing component operatively coupled to the first processing component, wherein the reconfigurable acoustic-based modem is configured to:
(i) receive and transmit data in real-time in an underwater environment, and
(ii) facilitate real-time software-controlled modulation adaptation between a plurality of communication protocols using the first processing component and the second processing component in an underwater environment, wherein the plurality of communication protocols comprises a first communication protocol and a second communication protocol that is different from the first communication protocol.

15. (canceled)

16. A system comprising:
a plurality of autonomous underwater vehicles (AUV) configured as a mesh network to operate in an underwater environment, wherein each AUV comprises:
a reconfigurable acoustic-based modem comprising:
a first processing component; and
a second processing component operatively coupled to the first processing component, wherein the reconfigurable acoustic-based modem is configured to:
(i) receive and transmit data in real-time in an underwater environment, and
(ii) facilitate real-time software-controlled modulation adaptation between a plurality of communication protocols using the first processing component and the second processing component in an underwater environment, wherein the plurality of communication protocols comprises a first communication protocol and a second communication protocol that is different from the first communication protocol.

17. (canceled)

18. (canceled)

19. The system of claim 16, wherein the first communication protocol comprises a low-range, low-speed communication protocol, and wherein the second communication protocol comprises a short-range, high-speed communication protocol.

20. The system of claim 16, wherein the plurality of communication protocols comprises at least one of Binary Frequency Shift Keying (B-FSK), Fast Frequency Hopping Frequency Shift Keying (FH-FSK), and orthogonal frequency division multiplexing (OFDM).

21. The system of claim 16, wherein each first processing component comprises a field reconfigurable gate array (FPGA).

22. The system of claim 16, wherein each reconfigurable acoustic-based modem is configured to operate underwater to provide a data rate between 2000 bits per second (bps) and 345 kilobits per second (Kbps).

23. The system of claim 16, wherein each reconfigurable acoustic-based modem has an operational range between 50 meters and 1 kilometer (km).

24. The system of claim 16, wherein each reconfigurable acoustic-based modem has an on-chip power between 0.5 Watts and 2.5 Watts.

25. The system of claim 16, wherein the real-time software-controlled modulation adaptation is used to facilitate rapid switching between short-range video communication and long-range data transmission.

26. (canceled)

27. (canceled)

28. (canceled)

29. (canceled)
